(19) United States
(12) Patent Application Publication
(10) Pub. No.: US 2014/0240353 A1
(43) Pub. Date: Aug. 28, 2014

(54) SYSTEM FOR AND METHOD OF AUGMENTING VIDEO AND IMAGES

(71) Applicant: Blendagram, Inc., Monte Sereno, CA (US)

(72) Inventors: Piyush Goel, Monte Sereno, CA (US); Anjan Ghose, Palo Alto, CA (US)

(21) Appl. No.: 13/830,074

(22) Filed: Mar. 14, 2013

Related U.S. Application Data
(60) Provisional application No. 61/770,077, filed on Feb. 27, 2013.

(51) Int. Cl. G06T 11/60; G06T 7/00

(52) U.S. Cl. CPC G06T 11/60; G06T 7/0085
USPC 345/633

(57) ABSTRACT

A system for and a method of augmenting video and images. A target area of an image frame is obtained. Boundary values for the target area of the image frame are obtained. Image data to be inserted into the image frame is also obtained. The image data is blended according to the boundary values for the target area using spectral methods. The blended image data is inserted into the target area of the image frame. The image can be a portion of a video clip in which case blended image data can be inserted in the target area for each of a plurality of image frames of the video clip to generate a resulting video clip.

This application claims the benefit of U.S. Provisional Application No. 61/770,077, filed Feb. 27, 2013, the entire contents of which are hereby incorporated by reference.

### BACKGROUND OF THE INVENTION

The present invention relates to video and image processing and display.

A video clip (or more simply a “video”) is a sequence of related graphic images called frames. Videos typically depict motion and may be accompanied by sound. Examples of videos include movies, television shows, instructional or educational videos, commercial advertisements, amateur-generated video content, and so forth. Videos are often delivered to viewers via the Internet. For example, video-sharing Internet websites provide viewers with access to a wide variety of videos that are uploaded by a variety of entities, including individuals and commercial enterprises. Other websites provide videos as a way of supplementing their content. For example, a news-oriented websites may provide news-related videos as well as text documents and photographs.

Many website operators and content producers use advertising to generate revenue. Advertisers pay fees to website operators for delivering advertising to potential customers. For example, a visitor to a website may select a video that is of interest to that visitor. The selected video may then be preceded by a video advertisement. The visitor must await completion of the video advertisement before the selected video is played. The number of times that the video advertisement is delivered to website visitors can be tracked and used as a basis for calculating advertising fees. However, having to watch such a video advertisement can be an annoyance for the website visitor, which can cause the visitor to stop watching the video advertisement, thereby defeating its purpose. Additionally, delivery of video advertisements requires network bandwidth, which has an associated cost. Delivery of video advertisements to mobile devices is particularly costly.

### SUMMARY OF THE INVENTION

The present invention provides a system for and a method of augmenting video and images. In an embodiment, a target area of an image frame is obtained. Boundary values for the target area of the image frame are obtained. Image data to be inserted into the image frame is also obtained. The image data is blended according to the boundary values for the target area using spectral methods. The blended image data is inserted into the target area of the image frame. The image can be a portion of a video clip in which case blended image data can be inserted in the target area for each of a plurality of image frames of the video clip to generate a resulting video clip. These and other embodiments are disclosed herein.

### BRIEF DESCRIPTION OF THE DRAWINGS

The present invention is described with respect to particular exemplary embodiments thereof and reference is accordingly made to the drawings in which:

FIG. 1 illustrates a block schematic diagram of a system within which embodiments of the present invention can be implemented;

FIG. 2 illustrates a block schematic diagram of an exemplary computer system within which embodiments of the present invention can be implemented;

FIG. 3 illustrates a method of augmenting video in accordance with an embodiment of the present invention;

FIG. 4 illustrates a projective transform for a planar target area in accordance with an embodiment of the present invention;

FIGS. 5A-B illustrate selection of four points in a first plane with known coordinates in a second plane in accordance with an embodiment of the present invention;

FIG. 6 illustrates a method of tracking a target area in accordance with an embodiment of the present invention;

FIG. 7 illustrates a method of detecting occlusions in accordance with an embodiment of the present invention;

FIG. 8 illustrates a method of generating a polygon that surrounds an occluding object in accordance with an embodiment of the present invention;

FIG. 9 illustrates a method of generating a target area outline in accordance with an embodiment of the present invention;

FIGS. 10A-F illustrate blending of additional content to a video frame in accordance with an embodiment of the present invention;

FIG. 11 illustrates use of guided interpolation for blending in accordance with an embodiment of the present invention;

FIG. 12 illustrates a method of blending video frames with additional content in accordance with an embodiment of the present invention;

FIG. 13 illustrates a method of solving a set of linear equations using FFT in accordance with an embodiment of the present invention; and

FIG. 14 illustrates a method of matching focus of additional content with focus of video frames in accordance with an embodiment of the present invention.

### DETAILED DESCRIPTION OF A PREFERRED EMBODIMENT OF THE INVENTION

In accordance with embodiments of the present invention, a system for and a method of augmenting a video clip with advertising or other content are provided. Advertising or other material can be integrated within a selected video. For example, a static graphic image, such as a corporate logo, can be added to a video such that it appears to the viewer that the graphic image was present at the time that the video was originally created. More particularly, a video clip may show a surface, such as a wall or the side of a building, among other elements within the video clip. The video can then be processed in accordance with the present invention so as to add a corporate logo or other image onto surface so that it appears to the viewer that the corporate logo or other added image was present when the video was originally filmed.

In accordance with an embodiment of the present invention, there is provided a method of inserting image data into a target area of an image frame comprising: obtaining a target area of an image frame; obtaining boundary values for the target area of the image frame; obtaining image data to be inserted into the image frame; blending the image data according to the boundary values for the target area using spectral methods; and inserting the blended image data into the target area of the image frame and displaying a resulting image frame on a display screen of a computing device.

In accordance with further embodiments of the present invention, the image frame can be a portion of a video clip and the method can further comprise repeating the steps of obtaining boundary values, calculating a vector B, solving a matrix equation using spectral methods and inserting blended image data into the target area of an image frame for each of a plurality of image frames of the video clip to generate a resulting video clip and further comprising displaying the resulting video clip on a display screen of a computing device. The video clip can be generated by photographing a three-dimensional tangible scene. The method can further include determining a measure of focus for the image frame and adjusting a focus of the blended image data in accordance with the measure of focus for the image frame. The boundary values for the target area can be in perceptual log color scale and wherein the image data to be inserted into the image frame can be in perceptual log color scale. The spectral methods can comprise Fast Fourier Transform. Solving a matrix equation can include solving nth order partial differential equations. Said blending can be limited to affecting only the target area of the image frame. Solving the matrix equation can employ Dirichlet boundary conditions. Solving the matrix equation can include solving second order Poisson partial differential equations. Solving the matrix equation can include solving fourth order Bi-harmonic partial differential equations. Solving fourth order Bi-harmonic partial differential equations can include: generating second degree coupled partial differential equations; using boundary values for the target area of the image frame to estimate a solution to the coupled partial differential equations; and iteratively solving the coupled partial differential equations to generate a final solution. The method can include communicating the resulting image from a network server to the computing device via a computer network.

In accordance with an embodiment of the present invention, there is provided a method of inserting image data into a target area of an image frame comprising: obtaining a target area of an image frame; obtaining boundary values for the target area of the image frame; determining a gradient for image data to be inserted into the image frame; calculating a vector B from the boundary values and the gradient; solving a matrix equation AF=B for the matrix F using spectral methods, the matrix A being a standard matrix and the matrix F representing blended image data; and inserting the blended image data into the target area of the image frame and displaying a resulting image frame on a display screen of a computing device.

In accordance with further embodiments of the present invention, the image frame can be a portion of a video clip and the method can further include repeating the steps of obtaining boundary values, calculating a vector B, solving a matrix equation using spectral methods and inserting blended image data into the target area of an image frame for each of a plurality of image frames of the video clip to generate a resulting video clip and further comprising displaying the resulting video clip on a display screen of a computing device. The video clip can be generated by photographing a three-dimensional tangible scene. The method can further include determining a measure of focus for the image frame and adjusting a focus of the blended image data in accordance with the measure of focus for the image frame. The boundary values for the target area can be in perceptual log color scale and the image data to be inserted into the image frame can be in perceptual log color scale. The method can further include converting the matrix F from perceptual log color scale to a linear color scale. The spectral methods can include Fast Fourier Transform. Fast Fourier Transform can be employed to invert the matrix A. Solving the matrix equation can include solving nth order partial differential equations. Solving the matrix equation can employ Dirichlet boundary conditions. Solving the matrix equation can include solving second order Poisson partial differential equations. Solving the matrix equation can include solving fourth order Bi-harmonic partial differential equations. Solving fourth order Bi-harmonic partial differential equations can include: generating second degree coupled partial differential equations; using boundary values for the target area of the image frame to estimate a solution to the coupled partial differential equations; and iteratively solving the coupled partial differential equations to generate a final solution. The method can further include communicating the resulting image from a network server to the computing device via a computer network.

In accordance with an embodiment of the present invention, there is provided a system for inserting image data into a target area of an image frame comprising: a network server configured to retrieve an image frame from data storage, the image frame having an identified target area; the network server being configured to obtain boundary values for the target area of the image frame; the network server being further configured to retrieve image data to be inserted into the image frame from data storage; and wherein the network server is further configured to blend the image data according to the boundary values for the target area using spectral methods; and wherein the network server is further configured to insert the blended image data into the target area of the image frame; and wherein the network server is further configured to communicate a resulting image to a computing device via a network for display by the computing device.

In accordance with an embodiment of the present invention, there is provided a non-transitory computer readable medium having stored thereon, a machine readable sequence of instructions, which when executed causes a computing device to perform a method of inserting image data into a target area of an image frame, the method comprising: obtaining a target area of an image frame; obtaining boundary values for the target area of the image frame; obtaining image data to be inserted into the image frame; blending the image data according to the boundary values for the target area using spectral methods; and inserting the blended image data into the target area of the image frame and displaying a resulting image frame on a display screen of a computing device.

In accordance with an embodiment of the present invention, there is provided a method of augmenting a video clip comprising steps of: obtaining a video clip comprising a sequence of frames, the video clip including a frame having an identified target area; tracking the target area across a plurality of frames of the video clip; identifying any occluding objects present within the tracked target area for each of the plurality of frames; obtaining image data to be inserted into the tracked target area for each of the plurality of frames; for each of the plurality of frames, blending the image data according to the boundary values for the target area using spectral methods, and inserting the blended image data into the target area of the image frame; and displaying a resulting video clip on a display screen of a computing device.

In accordance with further embodiment of the present invention, said tracking the target area can include: identifying a plane in three-dimensional space for the target area, the target area being defined by a set a points on the plane; estimating a position of the target area in a next frame of the video clip; generating a transformation matrix from the position of the target area in the next frame; and applying the transformation matrix to the target area to determine its position in the next frame of the video clip. The method can further include comparing the estimated locations of points within the target area to their corresponding locations in the prior frame to determine frame-to-frame movement for each of the points and removing outliers based on said comparison and wherein said generating the transformation matrix estimated locations of points within the target area that are not outliers. An occluding object can at least partially occlude the target area and wherein, for each frame in which the occluding object at least partially occludes the target area said identifying any occluding objects can include estimating a location of the occluding object in a frame of the video clip based on its location in a previous frame of the video clip and identifying pixels of the occluding object in the frame by generating a characteristic signature of the occluding object based on its estimated location and using the characteristic signature to separate pixels of the occluding object from pixels of the frame of the video clip and wherein said displaying the resulting video clip on a display screen of a computing device is performed so that the occluding object appears to pass in front of the inserted image data.

In accordance with an embodiment of the present invention, there is provided a non-transitory computer readable medium having stored thereon, a machine readable sequence of instructions, which when executed causes a computing device to perform a method of augmenting a video clip comprising steps of: obtaining a video clip comprising a sequence of frames, the video clip including a frame having an identified target area; tracking the target area across a plurality of frames of the video clip; identifying any occluding objects present within the tracked target area for each of the plurality of frames; obtaining image data to be inserted into the tracked target area for each of the plurality of frames; for each of the plurality of frames, blending the image data according to the boundary values for the target area using spectral methods, and inserting the blended image data into the target area of the image frame; and displaying a resulting video clip on a display screen of a computing device.

In accordance with an embodiment of the present invention, there is provided a method of tracking a target area of an image frame in a video clip, comprising: obtaining a video clip comprising a sequence of frames, the video clip including a frame having an identified target area; identifying a plane in three-dimensional space for the target area, the target area being defined by a set a points on the plane; estimating a position of the target area in a next frame of the video clip; generating a transformation matrix from the position of the target area in the next frame; applying the transformation matrix to the target area to determine its position in the next frame of the video clip; and storing data representing the position of the target area in a data storage device.

In accordance with further embodiments of the present invention, the method can further include repeating said steps of estimating, generating, applying and include storing for each frame of the video clip in which at least a portion of the target area appears. The method can further include inserting image data into the tracked target area of each frame of the video clip in which at least a portion of the target area appears and displaying a resulting video clip on a display screen of a computing device. The method can further include terminating said repeating said steps when a probability that the target area is located in the next frame falls below a threshold, wherein the probability is determined in said step of estimating a position of the target area in a next frame of the video clip. Said estimating can be performed using least squares minimization. Said estimating can be performed using a numerical computing application program. Said applying the transformation matrix can include performing perspective transformation. The transformation matrix can include a projective transform matrix. The set of points that identifies the target area can define a closed polygon that bounds the target area. Said estimating a position of the target area in a next frame of the video clip can include estimating locations of a points within the target area. The method can further include comparing the estimated locations of points within the target area to their corresponding locations in the prior frame to determine frame-to-frame movement for each of the points. The method can further include removing outliers based on said comparison and wherein said generating the transformation matrix estimated locations of points within the target area that are not outliers. The method can further include displaying the video clip on a display screen of a computing device. The tracked target area can be visibly identified during said displaying. The method can further include attenuating jitter in movement of the target area during display when jitter is observed during said displaying. Said attenuating can include applying wavelet suppression to the stored data representing the tracked positions of the target area. Said attenuating can utilize Haar wavelet suppression.

In accordance with an embodiment of the present invention, there is provided a system for tracking a target area of an image frame in a video clip, comprising: a network server configured to retrieve a video clip comprising a sequence of frames from data storage, the video clip including a frame having an identified target area; the network server being configured to identify a plane in three-dimensional space for the target area, the target area being defined by a set a points on the plane; the network server being further configured to estimate a position of the target area in a next frame of the video clip; and wherein the network server is further configured to generating a transformation matrix from the position of the target area in the next frame; and wherein the network server is further configured to apply the transformation matrix to the target area to determine its position in the next frame of the video clip; and wherein the network server is further configured to store data representing the position of the target area in a data storage device. Said network server can be configured to track a location of the tracked area in each frame of the video clip in which at least a portion of the target area appears. Said network server can be configured to insert image data into the tracked target area of each frame of the video clip in which at least a portion of the target area appears and to communicate a resulting video clip to a computing device via a network for display by the computing device.

In accordance with an embodiment of the present invention, there is provided a non-transitory computer readable medium having stored thereon, a machine readable sequence of instructions, which when executed causes a computing device to perform a method of tracking a target area of an image frame in a video clip, the method comprising: obtaining a video clip comprising a sequence of frames, the video clip including a frame having an identified target area; identifying a plane in three-dimensional space for the target area, the target area being defined by a set a points on the plane; estimating a position of the target area in a next frame of the video clip; generating a transformation matrix from the position of the target area in the next frame; applying the transformation matrix to the target area to determine its position in the next frame of the video clip; and storing data representing the position of the target area in a data storage device. The method can further include repeating said steps of estimating, generating, applying and storing for each frame of the video clip in which at least a portion of the target area appears.

In accordance with an embodiment of the present invention, there is provided a method of processing a video clip to identify an occluding object, comprising: obtaining a video clip comprising a sequence of frames, the video clip having an identified target area and an occluding object that at least partially occludes the target area; estimating a location of the occluding object in a frame of the video clip based on its location in a previous frame of the video clip; identifying pixels of the occluding object in the frame by generating a characteristic signature of the occluding object based on its estimated location and using the characteristic signature to separate pixels of the occluding object from pixels of the frame of the video clip; and storing at least an identification of the pixels of the occluding object in a data storage device.

In accordance with further embodiment of the present invention, the method can include repeating said steps of estimating, identifying and storing for each frame of the video clip in which the occluding object at least partially occludes the target area. The method can further include inserting image data into the target area of each frame of the video clip in which at least a portion of the target area appears and displaying a resulting video clip on a display screen of a computing device such that the occluding object appears to pass in front of the inserted image data. The method can further include repeating said steps of estimating, identifying and storing for each occluding object that at least partially occludes the target area. The location of the occluding object can be identified by a polygon. Said estimating can be performed by generating an optical flow matrix from a set of pixels bounded by a polygon that identifies the location of the occluding object in the previous frame of the video clip and using the optical flow matrix to identify a set of pixels in the frame of the video clip that correspond to the pixels bounded by the polygon. The method can further include generating a new polygon prior to identifying pixels of the occluding object. Said generating the new polygon can be performed to ensure that the new polygon surrounds the occluding object. Said generating the new polygon can include: identifying a set of boundary pixels for the polygon; determining a centroid for the set of boundary pixels; translating the centroid to the origin of a coordinate system; mapping pixels of the set to a histogram having n bins according to their angular position; and for each bin selecting a furthest pixel from the origin for defining the new polygon.

In accordance with further embodiment of the present invention, the method can further include extending the distance from the origin of the furthest pixels by a multiplier. The method can further include reversing said translating the centroid to the origin. The characteristic signature for the occluding object can include a value for each pixel of the occluding object. The characteristic signature can include a red, green, blue histogram. The characteristic signature can include a Guassian mixture model. Said using the characteristic signature to separate pixels of the occluding object from pixels of the frame of the video clip can use a Min-cut/Max-flow algorithm.

In accordance with an embodiment of the present invention, there is provided a system for processing a video clip to identify an occluding object, comprising: a network server configured to retrieve a video clip comprising a sequence of frames from data storage, the video clip having an identified target area and an occluding object that at least partially occludes the target area; the network server being configured to estimate a location of the occluding object in a frame of the video clip based on its location in a previous frame of the video clip; the network server being further configured to identify pixels of the occluding object in the frame by generating a characteristic signature of the occluding object based on its estimated location and using the characteristic signature to separate pixels of the occluding object from pixels of the frame of the video clip; and wherein the network server is further configured to store at least an identification of the pixels of the occluding object in a data storage device data.

In accordance with further embodiment of the present invention, said network server can be configured to repeat said steps of estimating, identifying and storing for each frame of the video clip in which the occluding object at least partially occludes the target area. Said network server can be configured to insert image data into the target area of each frame of the video clip in which at least a portion of the target area appears to communicate a resulting video clip to a computing device via a network for display by the computing device such that the occluding object appears to pass in front of the inserted image data.

In accordance with an embodiment of the present invention, there is provided a non-transitory computer readable medium having stored thereon, a machine readable sequence of instructions, which when executed causes a computing device to perform a method of processing a video clip to identify an occluding object, the method comprising: obtaining a video clip comprising a sequence of frames, the video clip including a frame having an identified target area; identifying a plane in three-dimensional space for the target area, the target area being defined by a set a points on the plane; estimating a position of the target area in a next frame of the video clip; generating a transformation matrix from the position of the target area in the next frame; applying the transformation matrix to the target area to determine its position in the next frame of the video clip; and storing data representing the position of the target area in a data storage device.

Embodiments of the present invention can be used to augment video of any type or source, such as professionally-filmed videos, including but not limited to, movies, television shows and video advertisements, as well as amateur films and videos. The video to be augmented can be one that was filmed from the early days of motion pictures up to the present, including black and white films, Technicolor process or format, MPEG video, RGB video, and so forth. The videos can include YouTube video clips, academic lecture videos, do-it-yourself videos, movie trailers, entertaining video clips, and so forth. Additional advertising content can be integrated into a video which is itself a commercial advertisement, thus, providing co-branded advertising content.

The content with which the video is augmented can be a static image, such as a corporate logo, as in the example described above. While embodiments of the invention are described herein the context of static images, it will be apparent that the added content can also be dynamic, such as a depiction of a flashing sign. For example, rather than showing a static logo on a selected surface within the original video, a flashing sign can be shown, such that it appears that the flashing sign was present when the video was originally filmed. As another example, the content can be another video. For example, the original video can show a television screen. This video can be augmented in accordance with the present invention such that a second video appears to be playing on the television screen (i.e. as a video within a video).

An area depicted in the video to which the added content is to be placed (referred to as a “target” area) can include a substantially flat surface depicted in the video, such as the side of a building, a wall, a floor, a sidewalk, or the side of a bus or truck. However, the surface need not be substantially flat and can, instead, be cylindrical, round or of some other shape, including irregular shapes. Multiple target areas can be selected for a video.

The target area need have any particular orientation with respect to the field of view of the camera used to shoot the video or with respect to its line of sight. Thus, for example, the target area can be at an oblique angle with respect to the camera's line of sight. Additionally, the target area can move from frame-to-frame within the video and its angle with respect to the camera's line of sight can change from frame-to-frame. The size of the target area can also change from frame-to-frame with respect to the camera's field of view. For example, the side of a bus can be selected as the target area and the video can show the bus entering and then leaving the camera's field of view, all the while the orientation of the side of the bus is changing with respect to the camera's line of sight. The distance of the bus from the camera can also change as the bus travels toward or away from the camera, thus, changing the size of the target area. The present invention can preferably take into account and compensate for all of these changes on a frame-by-frame basis so that the resulting augmented video appears realistic as though the added content was present when the video was originally created.

Embodiments of the present invention can also preferably adjust the focus, color, perspective, size and shape of the additional content appropriately on a frame-by-frame basis so that the resulting augmented video appears realistic as though the added content was present when the video was originally created.

The content with which the video is augmented can be targeted to a specific audience. For example, the content can be location-dependent. In this case, a graphic logo representing a local business can be shown only to viewers that are located near the business. As another example, the content can be targeted to a specified demographic group. In this case, assuming that it is known that the viewer belongs to a specified demographic group (e.g., an age group, sex, or income range) the content can be specifically targeted to that demographic group. As another example, the content can be targeted to a specific individual. In this case, assuming the identity or some characteristic of an individual viewer is known (such as that person's web browsing history or on-line shopping history), then a video selected to be watched by that individual viewer can be augmented with content that is specific to that individual. In other words, a video can be specifically augmented for a single viewer.

An advantage of embodiments of the present invention is that commercial advertising content can be delivered without significantly distracting from the viewer's video watching experience. Specifically, the viewer is not forced to first watch something other than what the viewer selected. Additionally, embodiments of the invention can be flexibly applied to any video and multiple instances of additional content can potentially be integrated within a particular video. For example, the entire length of a video is potentially available for integrating additional content. An additional advantage of embodiments of the present invention is that because advertising content is embedded into a video, there is no requirement for additional bandwidth to be allocated to the advertising content, which is particularly advantageous for content delivered to mobile devices. A further advantage of embodiments of the present invention is that processing times to produce the resulting augmented video are manageable.

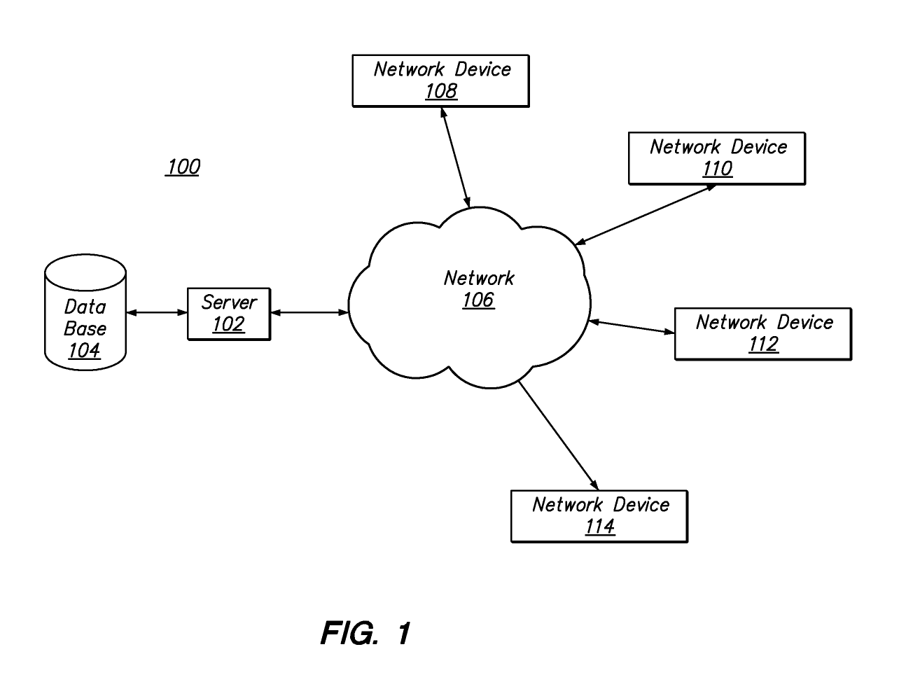

FIG. 1 illustrates a block schematic diagram of a system 100 within which embodiments of the present invention can be implemented. As shown in FIG. 1, a server 102 is coupled to a database 104 and to a data communication network 106. The network 106 may include, for example, a local area network, an intranet, a wireless network, a cellular communications network and/or a wide area network, such as the Internet. Network access network devices 108, 110, 112, and 114 may be implemented as various computing devices, such a desktop personal computer, a portable personal computer such as a laptop or notebook computer, a “smart” phone, a tablet computer, a personal digital assistant (PDA) or other device. The devices 108, 110, 112, 114 may communicate with the server 102 and with each other and with other devices by wireless or wired connections. While a single server 102 is shown, it will be understood that the functions of the server 102 may be performed by multiple servers or by a distributed server system or by a cloud computing environment.

In operation, the devices 108, 110, 112, and 114, send data and requests to the server 102. For example, video files, and additional content intended to augment the video files can be uploaded to the server 102 by any of the devices 108, 110, 112, and 114. The devices 108, 110, 112, and 114 can also request delivery of video files from the server 102 for viewing by any of the devices 108, 110, 112, and 114.

The server 102 can respond to requests from the devices 108, 110, 112, and 114. For example, the server can receive and store video files in database 104. The server 102 can process the video files in accordance with the methods described herein to produce processed video files, to store the processed video files in the database 104 and to make the processed video files available for delivery to devices 108, 110, 112, and 114 upon request.

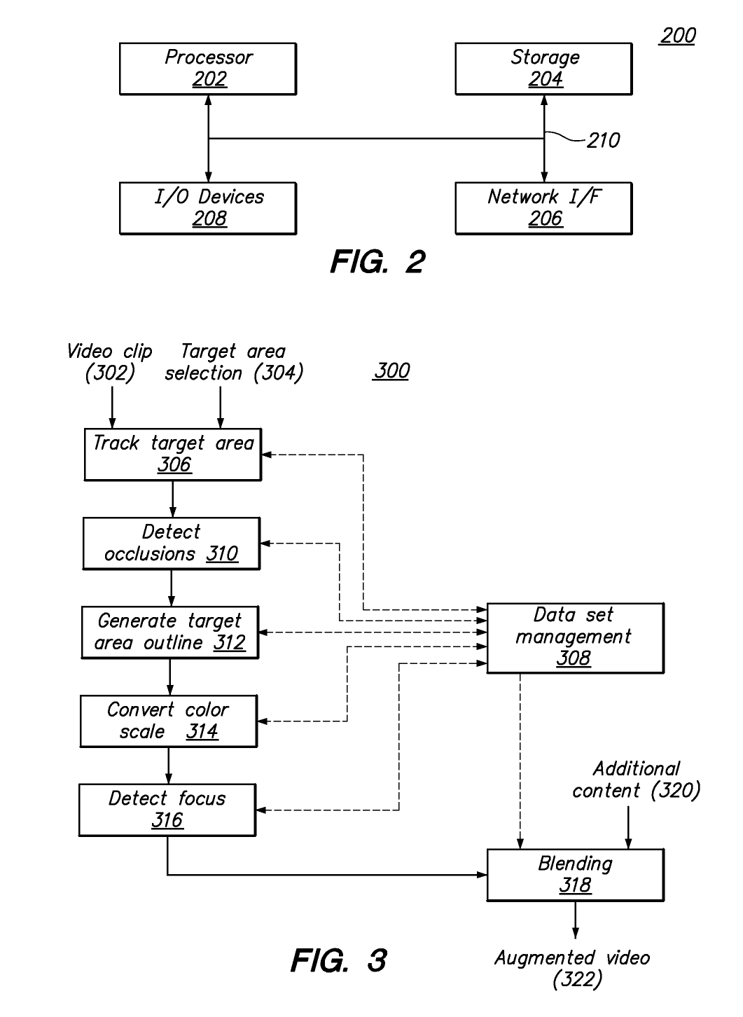

FIG. 2 illustrates a block schematic diagram of an exemplary computer system 200 within which embodiments of the present invention can be implemented. The server 102 can be configured as shown in FIG. 2. Also, any one of the devices 108, 110, 112, and 114 can be configured as shown in FIG. 2. The computer system 200 includes a processor 202, storage 204, a network interface 206 and input/output devices 208. A bus 210 or other communication medium provides a mechanism for communicating within the system 200. The processor 202 can perform processing tasks using data and software programs stored in storage 204. The storage 204 can include memory devices, such as a random-access memory (RAM) or other types of dynamic storage devices or media for storing information, including temporary variables and other intermediate information, for use during execution of instructions by processor 202. Storage 204 can include a read-only memory (ROM) 308, flash-memory or other type of non-volatile storage devices or media for storing information and/or software. Storage 204 can also include mass storage such as a magnetic disk or optical disk or other types of mass storage devices or media for storing information and/or software. The network interface interfaces the system 200 with one or more networks, such as the network 106.

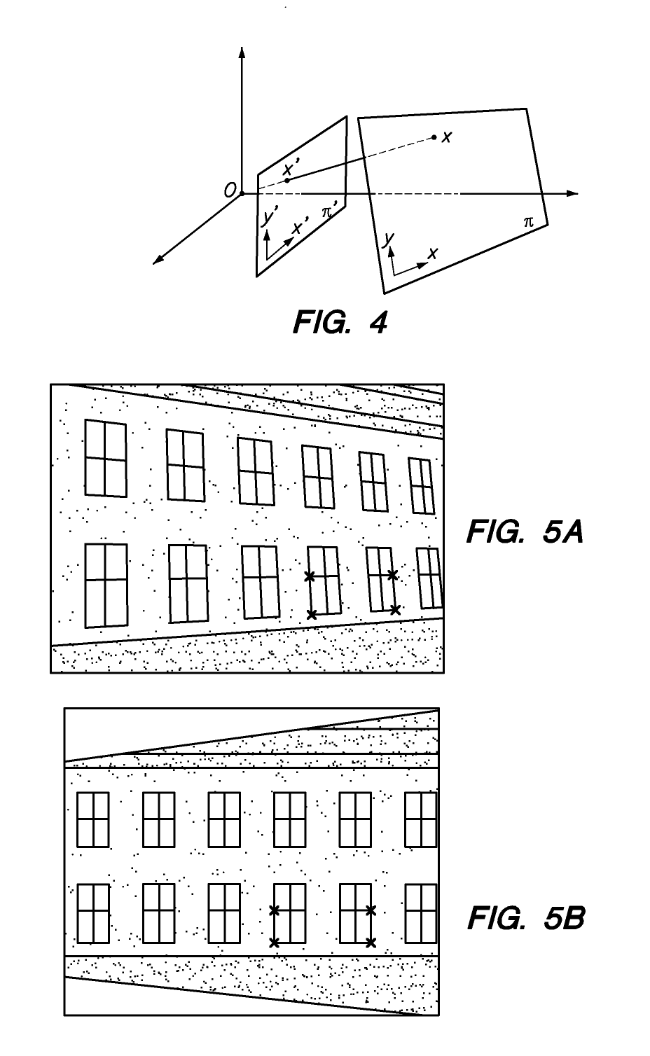

FIG. 3 illustrates a method 300 of augmenting video in accordance with an embodiment of the present invention. Inputs to the method 300 can be a video clip 302, a target area selection 304 and additional content 320. The video clip 302 can be, for example, uploaded to the server 102 (FIG. 102). Alternatively, a user may select a video clip that was previously uploaded to the server 102. The target area selection 304 identifies a target area for at least one frame of the video 302. For selecting the target area, a graphic user interface may be provided which allows a user to view the video clip and that allows the user to stop (or “pause”) the video clip so that a still image from the video is displayed. This can be accomplished by user accessing the server 102 through one of the network devices 108, 110, 112, and 114 or via a user interface 208 (FIG. 2) at the server 102. The user can then use a pointing device to select a desired target area from the displayed image. This can be accomplished, for example, by the user holding a selection button a computer mouse while the user traces the outline of target area. As another example, the user may more simply position a cursor in approximately the center of the desired target area and press a selection button. It will be apparent that the target area can be selected in other ways.

As described herein, the additional content 320 can be a static image, a dynamic changing image or a video clip. As shown in FIG. 3, much of the processing of the video clip 302 is performed without requiring the presence of the additional content 320. Rather, the additional content can be inserted into the process 300 near its end, in a blending step 318. This allows the video clip to be pre-processed so that it is ready to accept additional content 320. The pre-processed video clip can be stored (e.g. in database 104) until it is requested to be played for a viewer. Also, because the additional content 320 can be inserted into the process 300 near its end, this allows different additional content to be easily substituted. For example, in one instance the video clip 302 may be played for a first person with the additional content 320 being a first corporate logo. In a second instance, the same video clip 302 may be played for a second person, different from the first person, and with the additional content being a second corporate logo, different from the first corporate logo. As such, the video clip 302 and the additional content 320 are not bound together and are instead readily interchangeable.

In a step 306, the target area is tracked. This step uses the video 302 and the initial target area selection 304 to track the target area for each of a plurality of frames of the video 302. This tracking is preferably performed programmatically by the server 102 (FIG. 1). If the target area is present in all of the frames of the video, the tracking can be performed for all frames of the video 302. However, if the target area is present in only a portion of the frames of the video 302, then the tracking is performed for the frames in which the target area is present.

An output of the tracking step 306 is a data set that identifies the location of the target area for each frame. This tracking data set can be provided to a data set management process 308. The data set management process 308 can be implemented by the server 102 (FIG. 1) and involves managing data sets generated during the method 300. The data sets managed by the management process 308 can be stored at least temporarily in the database 104 (FIG. 1).

In a step 310, occlusions are detected. As used herein, the term “occlusion” refers to an object depicted in the video 302 that at least partially impinges upon or partially obscures the target area. For example, where the target area is located on a wall, the video may show a person walking in front of the wall and the target area. In this case, the person will at least partially obscure the target area as the person passes in front of the target area. Detecting and tracking the occluding object allows the system 100 to integrate the additional content to be placed in the target area 304 such that it will appear as though the occluding object is passing in front of the additional content. For example, where the target area is a wall and the additional content to be integrated into the video is a corporate logo, this will allow the logo to be incorporated such that it will appear that any objects passing in front of the wall will also pass in front of the logo. This will tend to give the appearance that the corporate logo was present when the video was originally created.

The occlusion detection step 310 can use data received from the data set management process 308. The step 310 is preferably performed programmatically by the server 102 (FIG. 1). Data representing the occlusions can be passed to the data set management process 308 for storage in database 104 (FIG. 1).

In a step 312 a target area outline is generated. The target area outline is preferably generated for each of the frames for which the target area is tracked. The outline for each frame preferably takes into account any occlusions detected in step 312. Thus, the target area outline for a particular frame will represent an outline of the target area but with the outline of any occluding objects excluded from the area outlined. The resulting area outlined represents the area into which the additional content is to appear in the integrated video.

The target area outlining step 312 can use data received from the data set management process 308. The step 312 is preferably performed programmatically by the server 102 (FIG. 1). Data representing the outlined areas which is generated for each frame during the outlining step 312 can be passed to the data set management process 308.

In a step 314, color scale can be converted. In a step 314, colors in the video 302 can be converted to logarithmic scale. Colors in the additional content 320 can also be converted to logarithmic scale. This color scale information is used to adjust the color scale of the additional content so that its color scale approximates that of the video 302, and preferably so that its color scale approximates that of the target area. For example, if the color scale of the video 302 is skewed toward blue (e.g., white objects appear somewhat bluish), then the color scale of the additional content should also be skewed toward blue. This will tend to give the appearance that the additional content was present when the video was originally created.

The color scale conversion step 314 can use data received from the data set management process 308. The step 314 is preferably performed programmatically by the server 102 (FIG. 1). Data representing the converted color scale which is generated during the color scale conversion step 314 can be passed to the data set management process 308.

In a step 316, focus is detected for the video 302. In general, the video 302 can have varying degrees of focus. The focus can be different for different objects depicted in the video 302. For example, the focus for an object can depend upon the focal distance of the camera and the distance of the object from the camera. The focus for objects can change from frame-to-frame. In the step 316, a measure of the focus for the target area is estimated for each frame for which the target area is tracked. This estimate is used later in the process 300 to adjust the focus of the additional content 320 so that its focus approximates that of the target area 304. For example, if the target area 304 appears in the background of the video clip 302 and is, therefore, somewhat out of focus, the additional content 320 should also be somewhat out of focus so that it will appear as though the additional content 320 was present when the video was originally filmed.

The focus can be estimated in step 316 by measuring edge thicknesses in frames of the video 304. Specifically, where objects are adjacent to each other in a video frame, the image of the frame will show a demarcation or edge between the objects. Similarly, where an object depicted in the video has areas of different colors, the image frame will generally show a demarcation or edge between the areas of different colors. When an edge is in sharp focus, the thickness of the edge will be very small. In contrast, when an edge is not in focus, the edge will appear blurred and therefore the edge will have a greater thickness.

In a preferred embodiment, edge thicknesses for the entirety of each tracked frame are determined. These edge thicknesses are then preferably weighted inversely by distance from the tracked area and a weighted average is determined. This weighting gives greater weight to edge thicknesses that are nearer to the tracked area. The resulting weighted average therefore approximates the focus of the tracked area.

The data representing the estimated focus obtained in step 316 can use data received from the data set management process 308. The step 316 is preferably performed programmatically by the server 102 (FIG. 1). Data representing the estimated focus obtained in step 316 can be passed to the data set management process 308.

In a step 318, the additional content 320 is blended with the processed video clip 302 to produce an augmented video clip 322. The blending step 318 preferably includes skewing the color scale of the additional content 320 according to results of the color scale conversion step 314. The blending step 318 preferably includes adjusting the focus of the additional content 320 according to results of the focus detection step 316. The blending step 318 preferably adjusts the perspective, scale, size and shape of the additional content 320 to match that of the outlined and tracked target area determined in steps 306-312. In the blending step, the additional content 320 is inserted into the outlined area of each frame of the tracked video. A result of the blending step 318 is the augmented video clip 322 which appears as though the additional content was present when the video was originally filmed.

The blending step 318 is preferably performed programmatically by the server 102 (FIG. 1). The resulting augmented video 322 can be stored in database 104 (FIG. 1) and/or provided to any of the network devices 108, 110, 112, 114 via the network 106.

Tracking

In accordance with the tracking step 306, the target area is tracked for each of a plurality of frames of the video. Where the target area encompasses a planar object, such as a wall, this tracking involves determining a transform to be applied to target area for each frame. While tracking is described herein in connection with planar objects, it will be apparent that that objects can be another shape, such as cylindrical, with appropriate modifications.

FIG. 4 illustrates a projective transform for a planar target area in accordance with an embodiment of the present invention. Referring to FIG. 4, assume that two-dimensional planes are π, π′ and that x, x′ denote projected co-ordinates of a point in three-dimensional space. Then, x′=H x, where H is 3×3 projective transform matrix.

H is a 3×3 non-singular homogeneous matrix with 8 degrees of freedom.

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

For a pinhole camera model, the matrix H is uniquely determined from four non-colinear points on a plane π and their corresponding locations on another plane π′. The matrix H accounts for both the movements of a camera and movements of a tracked plane. This includes rotation along x-, y- or z-axis and translations along x-, y- or z-axis.

To compute the matrix H, four points in the first plane are selected with known coordinates in the second plane. FIGS. 5A-B illustrate selection of four points in a first plane with known coordinates in a second plane, in accordance with an embodiment of the present invention. These points are shown in FIGS. 5A and 5B by the x's appearing in the images. The matrix H can be computed using these selected points by solving the equation above for H. Then, new locations for the target area can be computing using the following equation:

New location x′=Hx.

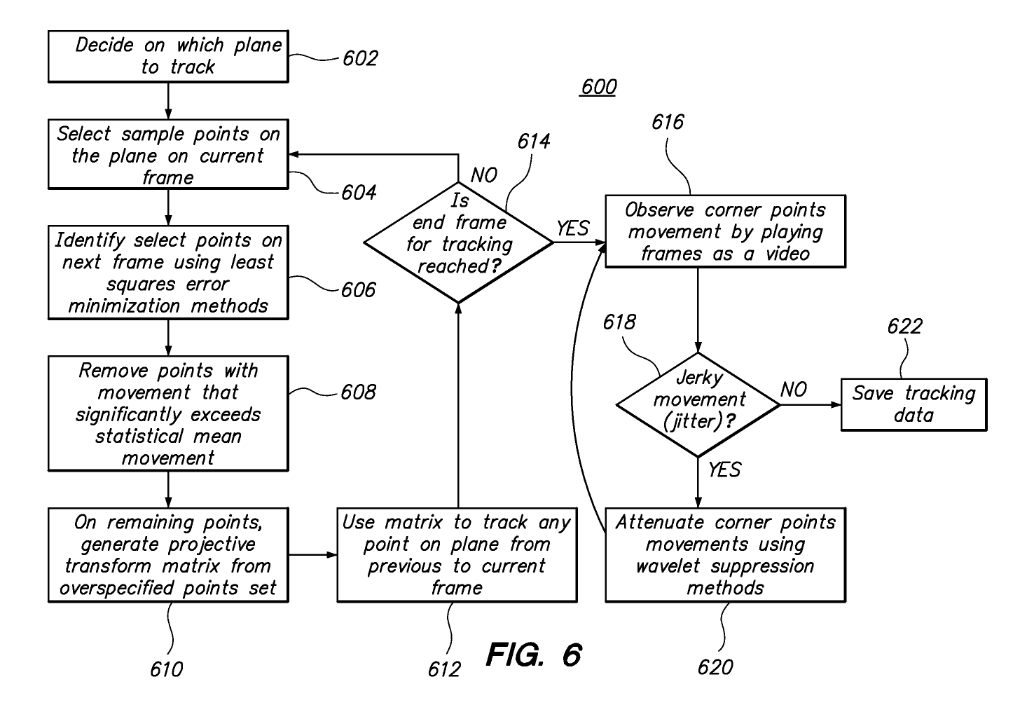

FIG. 6 illustrates a method 600 of tracking a target area in accordance with an embodiment of the present invention. The method 600 can be performed in the step 306 of FIG. 3. In a step 602, a plane in three dimensional space is identified. This plane is the plane π discussed above. In step 604, sample points or pixels in the plane π are identified in a frame of the video. These sample points (referred to as “corner points”) define a closed polygon. The area bounded by the polygon is the target area 304 (FIG. 3).

In a step 606, estimated locations of the corner points in a next frame of the video are computed. Locations of pixels within the polygon bounded by the corner points can also be estimated. This step can be performed in accordance with known methods, such those that employ least squares minimization. Matlab is an example of a commercially-available numerical computing application program that can be utilized to perform this step.

In an optional step 608, the estimated locations of the corner points determined in step 606 are compared to their locations in the prior frame to determine their movements from one frame to the next. Locations of pixels within the polygon bounded by the corner points can also be compared. Any corner points or pixels within the bounded polygon whose frame to frame movement is significantly outside a statistical mean of the frame to frame movements for all of the pixels can be considered to be an outlier. Such outliers are preferably removed from the data set.

In a step 610, points remaining in the data set can be used to generate a transformation matrix that represents frame to frame movement of the target area. The transformation matrix can be projective transform matrix. This step can be accomplished using known techniques, including for example, perspective transformation.

In a step 612, the transformation matrix generated in step 610 is then used to determine the location of the target area in the next frame of the video. More particularly, the transformation matrix can be applied to the corner points to determine their corresponding locations on the next frame.

In a step 614, a determination is made as to whether the current frame is the last frame in the sequence for which the target area is to be tracked. If not, then method of steps 604-612 is repeated for a next frame. This process is repeated for each frame of the sequence. In an embodiment, a user can identify a start frame and an end frame to define the sequence of frames for which this tracking process is performed. Alternatively, the beginning and ending frames can be detected programmatically by determining when a probability signature computed in step 606 is sufficiently small. The resulting tracking data can include a set of corner points for each frame which can be stored in the database 104.

The tracking method 600 can end once the location of the tracked area is determined for each frame of the sequence. However, in a preferred embodiment, the resulting tracking data is analyzed for jitter and, if excessive jitter is present, the tracking data is refined to reduce the jitter. Such jitter may have been introduced by the transformation matrices employed in step 612. In this case, in a step 616, the sequence of frames with the tracked area visually identified in the frames can be played for the user. If the user observes jerky movement of the tracked area (step 618), then this movement is preferably attenuated in a step 620. In step 620, wavelet suppression methods (e.g. Haar wavelet) can be utilized to reduce jitter. Steps 616, 618 and 620 can be repeated until the jitter is sufficiently reduced based on the user's visual observations. In step 622, the resulting tracking data can be saved, e.g. in database 104.

Occlusion Detection

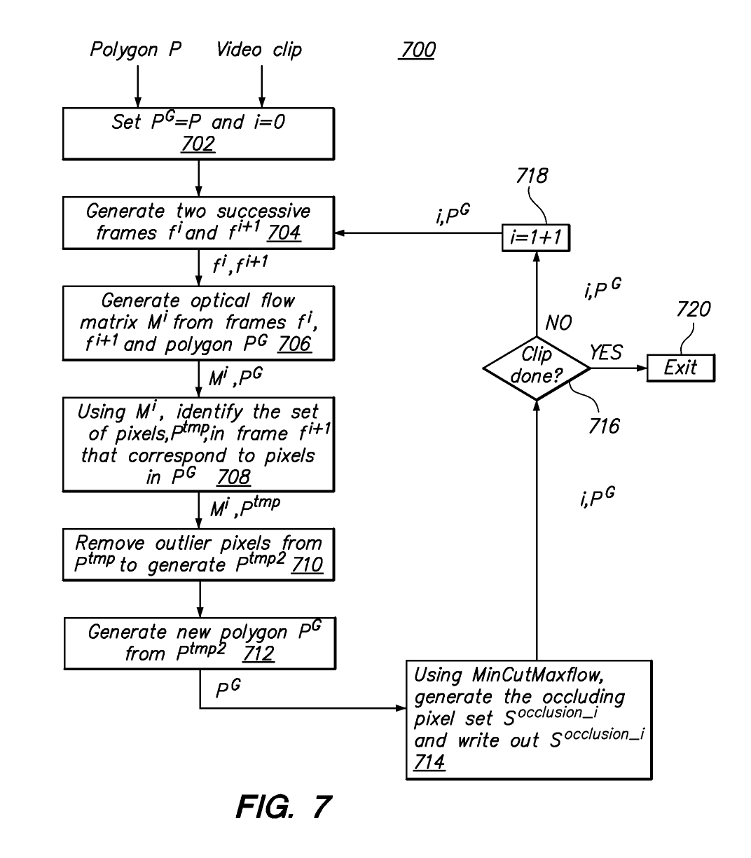

FIG. 7 illustrates a method 700 of detecting occlusions in accordance with an embodiment of the present invention. As explained herein, an occluding object is an object in the video clip 302 that passes in front of the target area 304 (FIG. 3). The method 700 can be performed in the step 308 of FIG. 3. The step 702 takes as input a polygon P that surrounds the occluding object and a video clip. The polygon can be entered manually by a user. To accomplish this, a graphic user interface may be provided which allows the user to view the video clip and that allows the user to stop (or “pause”) the video clip so that a still image from the video is displayed. For example, such a frame can show the occluding object before it passes in front of the target area. The user can then use a pointing device to trace the outline of the occluding object. A set of points or pixels P^{G} that define the polygon P can be stored by the server 102, e.g. in the database 104. Also in step 702, a frame counter can be initialized (i=0).

In a step 704, two successive frames fⁱ and fⁱ⁺¹ can be generated from the video clip. The initial frame f⁰ can be a frame in which the occluding object has not yet occluded the target area. In a step 706, an optical flow matrix Mⁱ can be generated from the frames fⁱ and fⁱ⁺¹ and the polygon P. The matrix Mⁱ tracks movement of the polygon P between the frames fⁱ and fⁱ⁺¹

In a step 708, the matrix is used to determine a set of points (i.e. pixels) p^{tmp} that correspond to the location of P in the frame fⁱ⁺¹. The set of points P^{tmp} is an estimate of the location of the occluding object given by the set of points P^{G} in the next frame fⁱ⁺¹. This step can be performed in a manner similar to that of step 606 in FIG. 6.

In an optional step 710, any corner points or pixels within the bounded polygon P^{tmp} whose frame-to-frame movement is significantly outside a statistical mean can be considered outliers and are preferably removed from the data set to form a second data set P^{tmp2}.

In a step 712, a new polygon P is generated from the second data set P^{tmp2}. The new polygon P is essentially a better estimate of the location of the occluding object in the current frame compared to the estimate generated in the step 708.

Thus, steps 702-712 form an estimate of the location of the occluding object in the current frame of the video clip based on its location in a previous frame of the video clip.

In a step 714, the data set P^{tmp2} and a set of points that defines the location of the target area (from step 306 of FIG. 3) for the current frame are used to generate an occluding pixel set S^{occlusion}^{_{—}}ⁱ. This is essentially the set of pixels in which the occluding object overlaps the target area for the current frame. In step 714, a characteristic signature of the occluding object is generated based on its estimated location and the characteristic signature is used to separate pixels of the occluding object from those of the background of the video frame. The characteristic signature can include a value for each pixel of the occluding object or for the polygon that bounds the occluding object. The characteristic signature can be, for example, a red, green, blue (RGB) histogram, or a Guassian mixture model. The separation performed in step 714 is preferably performed using a known Min-cut/Max-flow algorithm. The sets of pixels S^{occlusion}^{_{—}}ⁱ generated in the step 714 can be stored by the server 102, e.g. in the database 104.

This process can be repeated for each frame of the video clip, or at least each frame in which the occluding object overlaps any of the target area. Thus, in a step 716, a determination is made as to whether the last frame is reached. If not, the counter i is incremented in a step 718 and the steps 704-714 are repeated. Once the last frame is reached, the method 700 can exit in a step 720.

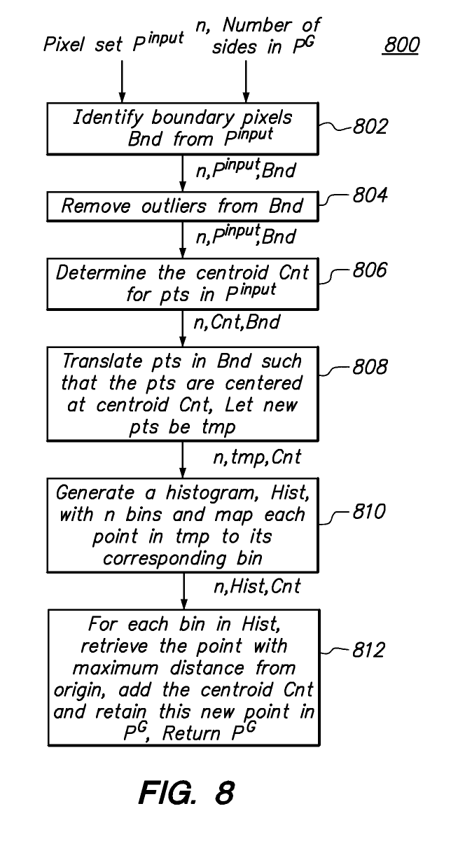

FIG. 8 illustrates a method 800 of generating a polygon that surrounds an occluding object in accordance with an embodiment of the present invention. The method 800 can be performed in the step 712 of FIG. 7. Specifically, it has been found that the separation algorithm, Min-cut/Max-flow, performed in the step 714 works best if it receives as input a polygon that is somewhat larger than the occluding object so that it is ensured that the occluding object is completely bounded by the polygon. Thus, the method 800 essentially enlarges the area bounded by the polygon P before the polygon is further processed by the step 714.

A step 802 receives as input a pixel set P^{input}, which can be the same as the pixel set P^{tmp2}, generated in step 710 of FIG. 7. In the step 802, a set of boundary pixels Bnd is generated from the set P^{input}. The boundary pixels Bnd are essentially the pixels of the set P^{input} other than the interior pixels. In a step 804 any outlier pixels are preferably removed from the set Bnd. The method 800 also receives as input a number n which can represent a number of sides of the polygon P. The number n can be, for example, 36 or 72, or some other number. The number n is preferably a factor of 360 which is the number of degrees in a circle.

In a step 806, a centroid Cnt of the set of pixels P^{input} is determined from the set of pixels P^{input}. In a step 808, the points in Bnd are translated such that the centroid Cnt is located at the origin (0, 0) of a two-dimensional Cartesian coordinate system.

In a step 810, a histogram Hist is generated having n bins. Each bin represents 360/n degrees of a circle centered at the origin. Thus, where n is equal to 72, then each bin represents a 5 degree wide sector of the circle centered at the origin. The pixels in each sector are thus placed in the corresponding histogram bin according to their angular orientation with respect to the origin.

In a step 812, for each bin of the histogram Hist the pixel furthest from the origin is identified. In addition, the distance of the furthest pixel is multiplied by a selected multiplier, greater than 1, so that its distance from the origin is increased. For example, the multiplier can be selected to be between 105% and 120%. The points at the new distance are identified as boundary points for an enlarged occlusion area. These points can then be translated by adding the centroid Cnt determined in step 806, effectively reversing the translation performed in step 808. As a result, the process 800 returns a set of points that defines a polygon that surrounds the occluding object and is somewhat larger than the occluding object so that it is ensured that the occluding object is completely bounded by the polygon. This process can be repeated for each frame in which the target area is at least partly occluded. The polygon data generated by the method 800 can be stored by the server 102, e.g., in database 104.

Target Area Outline

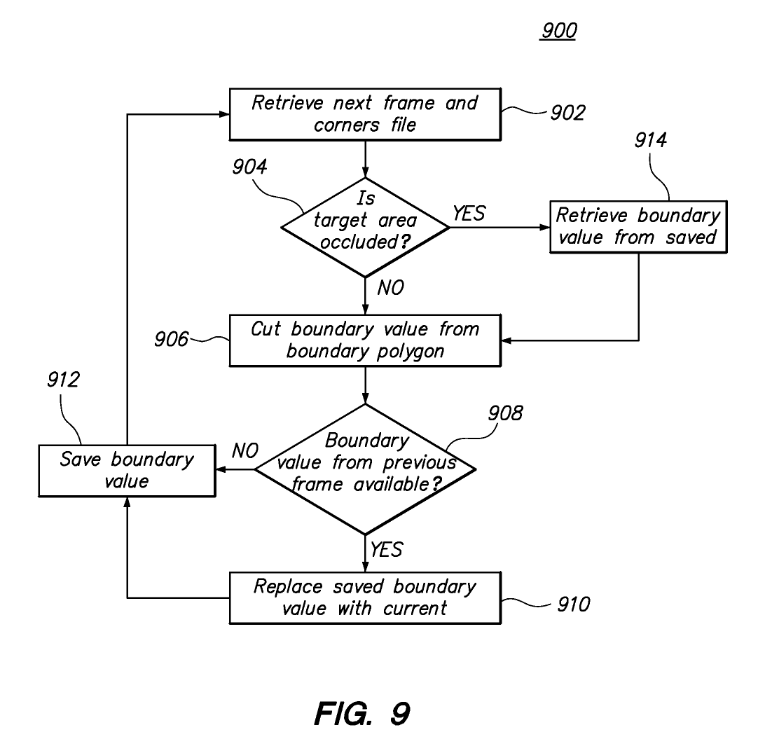

FIG. 9 illustrates a method 900 of generating a target area outline in accordance with an embodiment of the present invention. The method 900 can be performed in the step 312 of FIG. 3. Specifically, the method 900 generates an outline of the target area 304 for each of the frames for which the target area is tracked. This outline for each frame preferably takes into account any occlusions detected in step 312. Thus, the target area outline for a particular frame represents an outline around the target area 304 but with any occluding objects excluded from the area outlined. The resulting area outlined represents the area into which the additional content is to appear in the integrated video clip.

The data generated by the method 900 includes the color values (referred to as “boundary values”) for pixels surrounding the target area 304. These color values are obtained for pixels of frames of the original video clip 302. These color values are used in the blending step 318 (FIG. 3).

The method 900 uses as input a set of corner points for each frame that defines the target area 304 as it moves from frame to frame. These corner points can be generated by the tracking step 306 of FIG. 3. Collectively, these sets of corner points can be referred to as a “corners file.” In addition, the method 900 uses data that identifies a set of pixels for each frame in which the occluding object overlaps the target area (e.g. referred to as S^{occlusion}^{_{—}}ⁱ from step 308 of FIG. 3).

The method 900 is repeated for each pixel located on the boundary of the target area as defined by the corner points and for each of several frames of the video clip 302. Thus, in a step 902, a frame and the corner points for the frame can be retrieved, e.g. from database 104. In a step 904, for a first pixel, a determination is made as to whether the pixel is occluded by the occluding object. This can be accomplished by comparing the location of the current pixel to the set S^{occlusion}^{_{—}}ⁱ for the current frame. In a step 906, if the pixel is not occluded, the boundary value for the pixel can be obtained from a “bounding polygon.” The bounding polygon is determined from the corner points for the current frame and is preferably the set of pixels that lie just outside the boundary of the target area (by one or two pixels only). If the boundary of the target area lies at the edge of the frame (e.g., where the target area extends off the edge of the frame), then the bounding polygon preferably coincides with the edge of the frame.

In a step 908, a determination is made as to whether a boundary value for this same pixel was already obtained for a prior frame. If so, the saved boundary value is replaced with the value obtained from the current frame in a step 910 and saved in a step 912. If a boundary value for this same pixel was not obtained for a prior frame, the value is saved (without replacing a prior value) in step 912.

Returning to step 904, if the current pixel is occluded, then a saved boundary value for this pixel from a prior frame is obtained in a step 914. This value is preferably obtained from the frame closest in time to the current frame for which the pixel was not occluded by the occluding object. This value can be saved in step 912.

A result of the method 900 is a set of boundary values (e.g. red, green and blue color values) for each pixel surrounding the target area and any occluding objects. A set of such boundary values is provided for each frame of the video clip 302. This data generated can be stored by the server 102, e.g., in database 104.

Color Space

In accordance with the color scale conversion step 314, color scale of pixels of the video clip 302 is converted to logarithmic scale. More specifically, the color scale of the boundary values determined for the target area can be converted to logarithmic scale in step 314. This step does not need to be performed for frames in which no portion of target area appears. In general, raw image data of the video 302 frame and the additional content 320 is in 24-bit RGB format. These RGB channels tend to introduce artifacts during the blending step 318. Therefore, in accordance with an embodiment of the present invention, color conversion and correction is performed in order to reduce or avoid such artifacts. RGB color space employs linear scales. In one embodiment, the RGB color space can be converted to some other linear color space in which these artifacts are minimized. For example, CIE L*a*b* or CIE L*u*v* can be employed. However, image artifacts tend to persist when these linear color scales have been employed in conjunction with the present invention.

It is desired that the resulting augmented video 322 has a perceptual color space that is consistent with functioning of the human eye. It is also desired that the blending of the additional content is re-illumination invariant when blended with frames of the video 302 that have varying shadows. Re-illumination invariant means that of the differences of color vectors in the color space should be invariant under different illuminations. This ensures the integrity of the additional content under different illuminations and ensures that gradients can be computed simply as component-wise subtractions for all the channels.

Additionally, it is desired for differences in color vector space to match perceptual differences. This is referred to as l₂ norm invariance, which means that differences between color vectors in the color space and the corresponding differences in the perceptual space are invariant. This helps to ensure that color changes made during the blending step 318 correspond to human perceptual system which helps to ensure that blended images are visually consistent and the original images of the video 302 are not distorted (except for the identified and tracked target areas).

The following mathematical model illustrates operation of a preferred embodiment of the present invention. It is assumed that re-illumination is approximated by multiplying each tri-stimulus value by a scale factor, where tri-stimulus values comprise a vector in the color space. Let x and x′ be vectors in a color space XYZ; let a matrix B comprise a new basis for color vectors x, x′; let D be a diagonal matrix modeling re-illumination; and let F be a 3D color space parameterization to be solved for.

Re-Illumination Invariance

F(x)−F(x′)=F(B⁻¹DBx)−F(B⁻¹DBx′)

l₂ norm invariance

d(x,x′)=∥F(x)−F(x′)∥

where d(•) denotes the perceptual distance, and ∥•∥ denotes l₂ norm.

Next, we determine B, D and F. For invariance, it follows that solution F is of the following form:

F(x)=A*(ln(B*x))

where x is a color vector in color space RGB; A is 3×3 invertible matrix; B is a 3×3 invertible matrix; and ln is natural logarithm (logarithm to the base e, where e is an irrational and transcendental constant approximately equal to 2.71828182). The Matrix B transforms color space XYZ to the desired basis in which re-illumination corresponds to a multiplication by a diagonal matrix. The Matrix A captures perceptual distances. In accordance with the present invention, both matrices A and B can be empirically determined by adjusting their values to achieve visually satisfactory results.

Focus Detection

In step 316, focus of the video 302 is detected. Specifically, focus of the target area of the video is preferably detected so that the focus of the additional content can be adjusted to be consistent therewith. In general, focus (also referred to as blur) of additional content 320 is different from the focii inherent in the video 302 frames. Consequently, if focus is not appropriately taken into account, the additional content will not visually blend well with the frames of the video 302.

In a preferred embodiment, an average of edge widths in the video frame is used as a basis for measuring blur. The blur measure of an image can be an average edge width of all significant edge pixels. This can include obtaining a ratio of blurred edge pixels to total number of edge pixels. This ratio can be defined as the blur measure of an image. An edge width at an edge pixel can be defined as the number of pixels between two extremes on the either side of the edge pixel. Edge pixels can be identified by known edge detection algorithms, such as Canny edge detector or Sobel edge detector.

To determine the blur of an image, edge pixels can be identified by subtracting luminance of a pixel (i, j) from its neighbors (i−1,j) and (i,j−1) in the image. Blurred edge pixels are identified by removing edge pixels that fall on sharp edges in in the image.

A perceptual blur measure can be determined by applying a low-pass filter K to image F in order generate blurred image B:

B=F*K

where K is the kernel [1 1 1 1 1 1 1 1 1]/9 and * denotes convolution.

For ∀i,j, generate “edge pixels” for image F and its blurred image B.

D_{H}^{F}(i,j)=F(i,j)−F(i−1,j)D_{H}^{B}(i,j)=B(i,j)=B(i−1,j)

D_{V}^{F}(i,j)=F(i,j)−F(i,j−1)D_{V}^{B}(i,j)=B(i,j)−B(i,j−1)

Count the pixels on sharp edges and all edges, along x and y-axis.

$${s}_{H}^{S} = {\sum }_{i , j} max ( 0 , {D}_{H}^{F} ( i , j ) - {D}_{H}^{B} ( i , j ) )$$

$${s}_{H}^{F} = {\sum }_{i , j} max ( 0 , {D}_{H}^{F} ( i , j ) )$$

$${s}_{V}^{s} = {\sum }_{i , j} max ( 0 , {D}_{V}^{F} ( i , j ) - {D}_{V}^{B} ( i , j ) )$$

$${s}_{V}^{s} = {\sum }_{i , j} max ( 0 , {D}_{V}^{F} ( i , j ) )$$

Blur measure:

β=max(1−S_{H}^{S}/S_{H}^{F},1−S_{V}^{S}/S_{V}^{F})

The above-described measurement is also provides a perceptual blur metric which means that it approximates human perception of blur. It will be apparent that some other metric of blur could be employed. Specifically, the above blur metric is determined without reference to any other image. Thus, it is a measure of absolute blur. In alternative embodiments, a relative blur metric could be employed, or a different absolute blur metric could be employed.

The blur measure for the video 302 frames can be determined as above. For the additional content 320, it expected that in most cases, the blur will be negligible at least with respect to corporate logos and similar content. For other content, the blur can also be measured as above. It will be apparent, however, that the blur measure for the video 302 and for the additional content 320 can be obtained in a different manner.

The blur of the additional content 320 is preferably made to substantially match that of the video 302. This can be accomplished, for example, by convolving the additional content image data with a Gaussian kernel pyramid until a blur measure obtained for the additional content substantially matches a blur measure obtained for the video clip 302.

Blending

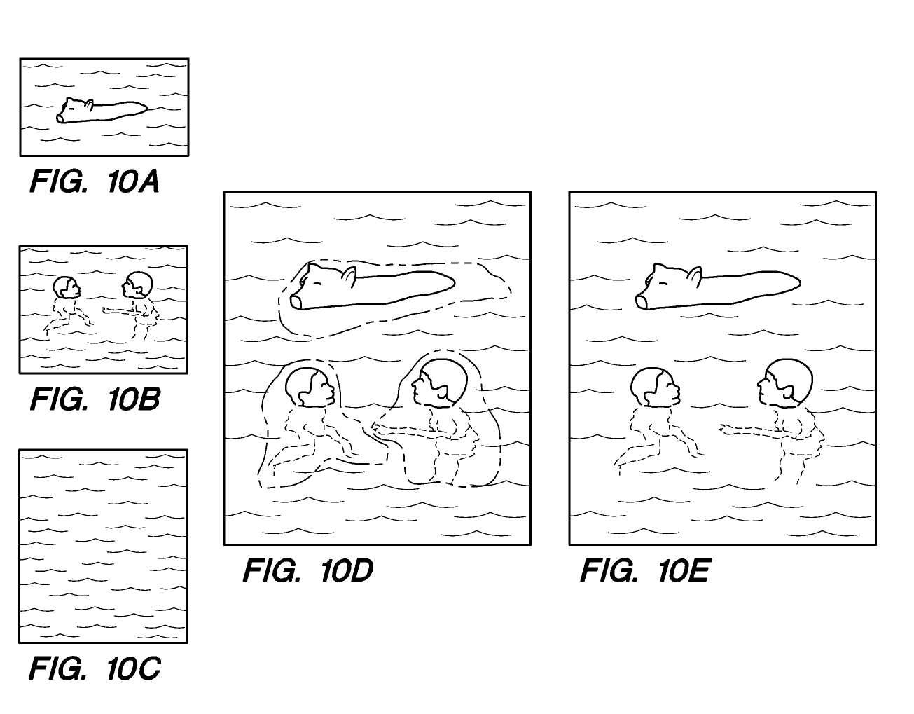

FIGS. 10A-F illustrate blending of additional content to a video frame in accordance with an embodiment of the present invention. Specifically, FIGS. 10A and 10B show additional content 320 that can be used to augment a frame of a video 302 shown in FIG. 10C. In this example, additional content shown in FIG. 10A is an image of a bear swimming in a lake, while the additional content shown in FIG. 10B is an image of two children swimming in a pool. The frame to be augmented shown in FIG. 10C is an image of shallow water near a beach. FIG. 10C also shows target areas identified by outlines. FIG. 10D shows a resulting image when the additional content from FIGS. 10A and 10B is simply inserted into the target areas of FIG. 10C. The result is not particularly realistic as appropriate blending of the images has not yet been performed. FIG. 10F shows the resulting image after blending is performed in accordance with an embodiment of the present invention. As can be seen from FIG. 10F, the resulting image realistically depicts the children and the bear swimming together.

In general, nth order partial differential equations (PDE) can be employed for blending accordance with the present invention. Two examples of partial differential equations (PDE) that can be employed for blending are:

Poisson (second order) PDE:

$$\frac{{\partial }^{2} f}{\partial {x}^{2}} + \frac{{\partial }^{2} f}{\partial {y}^{2}} = v ( x , y )$$

And Biharmonic (fourth order) PDE:

$$\frac{{\partial }^{4} f}{\partial {x}^{4}} + \frac{{\partial }^{4} f}{\partial {y}^{4}} = s ( x , y )$$

Either can be specified with the following Dirichlet boundary conditions:

f|_{∂Ω}=f*|_{∂Ω}

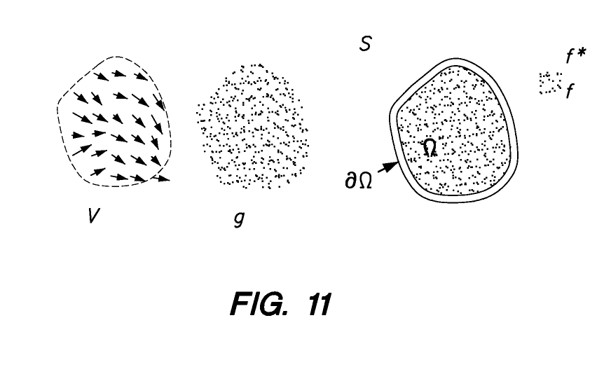

FIG. 11 illustrates use of guided interpolation for blending in accordance with an embodiment of the present invention. For Poisson PDE, let S be an image and let Ω be a closed subset of S with boundary ∂Ω. Let f* be scalar function defined over S minus the interior Ω and let f be an unknown scalar function defined over the interior of Ω. Let v be gradient vector field defined over Ω. An unknown function f interpolates in domain Ω the destination function f, under guidance of vector field v which can be a gradient field of a source function g.

Poisson PDE-based guided interpolation can be performed by solving the following minimization problem:

$$\{ \begin{matrix}{min}_{f} \int {\int }_{Ω} {‖ ∇ f - v ‖}^{2} \\ f {{\vert}_{\partial Ω} = f * \vert}_{\partial Ω}\end{matrix}$$

To solve this, Dirichlet boundary conditions are added to the Poisson equation:

$$\{ \begin{matrix}{∇}^{2} f = ∇ \cdot v \\ f {{\vert}_{\partial Ω} = f * \vert}_{\partial Ω}\end{matrix}$$

Then, a discrete Poisson solver is used for PDE. The minimization can be directly discretized as follows:

$${min}_{f \vert Ω} {\sum }_{〈 p , q 〉 ⋂ Ω \neq 8} {( {f}_{p} - {f}_{q} - {v}_{pq} )}^{2} with {f}_{p} = {f}_{p}^{*} for ∀ p ∈ \partial Ω$$

Taking the partial derivative:

$$for ∀ p ∈ Ω , \vert {N}_{p} \vert {f}_{p} - {\sum }_{q ∈ {N}_{p} ⋂ Ω} {f}_{q} = {\sum }_{q ∈ {N}_{p} ⋂ \partial Ω} {f}_{q}^{*} + {\sum }_{q ∈ {N}_{p}} {v}_{pq}$$

A partial derivative for interior points can be given as follows:

$$\vert {N}_{p} \vert {f}_{p} - {\sum }_{q ∈ {N}_{p}} {f}_{q} = + {\sum }_{q ∈ {N}_{p}} {v}_{pq}$$

where N denotes neighborhood of pixel p.

A discrete Poisson Solver for Poisson PDE can be employed using discrete partial derivatives that correspond to convolution with a 4×4 kernel. In matrix form, this implies a classical, sparse (banded), symmetric, positive-definite system A F=B, where A is coefficient matrix, and B, guidance vector, is obtained from the source image. The Matrix A is very large. For example, for image of size 100×100 pixels, matrix A is 10,000×10,000. Thus, this matrix cannot be inverted with classical methods. Iterative methods can be used to solve A F=B. Various known iterative methods can be employed, such as Gauss-Seidel iteration with successive over-relaxation, V-cycle multi-grid, and conjugate gradient method. However, these iterative methods are relatively slow for videos.

In accordance with an embodiment of the present invention, discrete bi-harmonic PDE is employed. This is similar to Poisson PDE except partial derivatives correspond to convolution with large kernel of size 5×5. A coupled equation approach can be employed which decouples the bi-harmonic equation into two coupled Poisson PDE's:

Δv=g(x,y),(x,y)ε over Ω,v(x,y)|_{∂Ω}=q(x,y)*|_{∂Ω}

Δf=v(x,y),(x,y)ε over Ω,f(x,y)|_{∂Ω}=f(x,y)*|_{∂Ω}

The above two equations can be iteratively solved using iterative methods such as Gauss-Seidel iteration with successive over-relaxation. Quality of blend is superior to Poisson PDE. Quality improves as a consequence of the larger kernel. However, this also can be fairly slow for videos.

Disadvantages of such a technique are that kernel sizes are fixed for Poisson and bi-harmonic PDE (4×4 for Poisson PDE and 5×5 for Bi-harmonic PDE); iterative conversions methods are slow for videos which can comprise tens of thousands of frames. Also backgrounds of source and target images should be similar and these methods are operable for manually editing one image at a time. An advantage of such a technique is that the quality of blending is good if the backgrounds of the source and target are similar.

Ideally, the quality of blending is at least as good, if not better than Poisson or bi-harmonic PDE. Also, the kernel sizes should be configurable, the blending should be insensitive to the backgrounds of the source and target frame and the blending process should take on the order of milliseconds per frame. Such an algorithm would be at least an order of magnitude faster in speed over the existing state of the art algorithms and implementations.

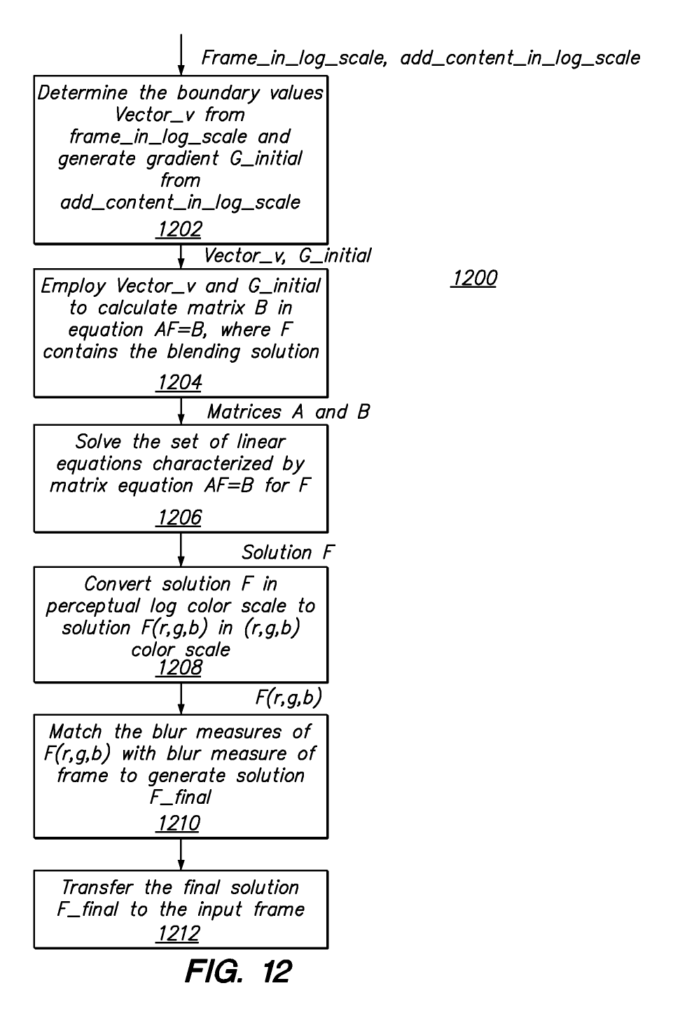

FIG. 12 illustrates a method 1200 for blending video frames with additional content in accordance with an embodiment of the present invention. The method 1200 can be performed in the step 318 of FIG. 3. The method 1200 takes as input, the frame data in log scale as well as the additional content in log scale. This can be the same pixel data as was generated in step 314 (FIG. 3).

In a step 1202, a boundary value vector Vector_v is determined from the frame data in log scale. A gradient G_initial is determined from the additional content in log scale. In a step 1204, the Vector_v and G_initial are used to calculate the matrix B in equation A F=B, where A is a standard matrix and F contains the blending solution.

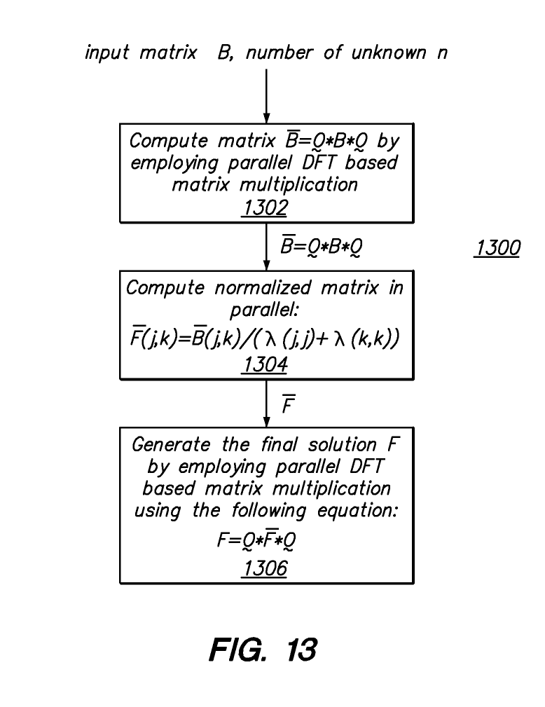

In a step 1206, the set of linear equations characterized by matrix equation A F=B is solved for F. In a preferred embodiment, this step involves the use of spectral methods, and specifically fast Fourier transforms. FIG. 13 illustrates a method 1300 of solving a set of linear equations using FFT in accordance with an embodiment of the present invention. The method 1300 can be performed in the step 1206 (FIG. 12). Referring to FIG. 13, in a step 1302, the matrix B̅=Q*B*Q is computed by employing a parallel DFT based matrix multiplication method.

A preferred Poisson PDE algorithm is now described. In discrete matrix form, Poisson PDE equation A F=B can be rewritten in the following form:

A*F=T*F+F*T=B

where: F is a matrix comprising the discrete n unknowns of earlier function f; B is the gradient matrix of the additional content and T is the following symmetric tri-diagonal matrix:

$$T = \begin{matrix}2 & - 1 & 0 & 0 & …0 \\ - 1 & 2 & - 1 & 0 … & 0 \\ 0 & - 1 & 2 & - 1 … & 0 \\ 0 & 0 & 0 … & - 1 & 2\end{matrix}$$

A special structure of matrix T leads to its following factorization:

T=Q*λ*Q

where matrix Q comprise eigenvectors of matrix T, and λ is a diagonal matrix comprising eigenvalues of T.

λ(j)=2*(1−cos(π*j/(n+1))

Q(j,k)=Q(k,j)=\sqrt{2/(n+1)}*sin(π*(k+1)*+(j+1)/(n+1))

Q is imaginary part of the following Discrete Fourier Transform (DFT) matrix:

DFT(j,k)=cos(π*j*k/(n+1))+i*sin(π*j*k/(n+1))

Compute:

B̅=Q*B*Q

Referring to FIG. 13, in a step 1304, for each F(j,k) the following normalized matrix is computed in parallel:

F̅(j,k)= B̅(j,k)/(λ(j,j)+λ(k,k))

Then, in step 1306 the solution F is generated by employing parallel DFT based matrix multiplication using the following equation:

F=Q* F̅*Q

The above algorithm comprises four large matrix-to-vector multiplications. However, since matrix Q=Im(DFT), each matrix-to-vector multiplication is equivalent to a multiplication with matrix DFT followed by a projection of the imaginary part. Or, equivalently, each matrix-to-vector multiplication corresponds to discrete FFT of the corresponding vector followed by a projection of the imaginary part.

Unlike iterative convergence methods, the above-described method provides an exact solution. The quality of the blending is improved.

Large matrix-to-vector multiplication is performed via FFTs. According the time required to perform the computations can be given as:

O(n*log₂n)

In a preferred embodiment, each FFT is implemented on a parallel graphic computer (e.g. GeForce 8000). For n=10,000, time for a matrix-to-vector multiplication via FFT is ˜2-3 milliseconds. For n=10,000, blending algorithm takes ˜7-8 milliseconds per frame. Multiple frames are processed in parallel. Consequently, average blending time per frame is approximately 2-3 milliseconds.

Referring to FIG. 12, in a step 1208, the solution F in perceptual log color scale is converted to a solution F(r,g,b) in RGB color scale. In a step 1210, the blur measures of F(r,g,b) are matched with blur measures of the frame to generate a solution for F, F_final.

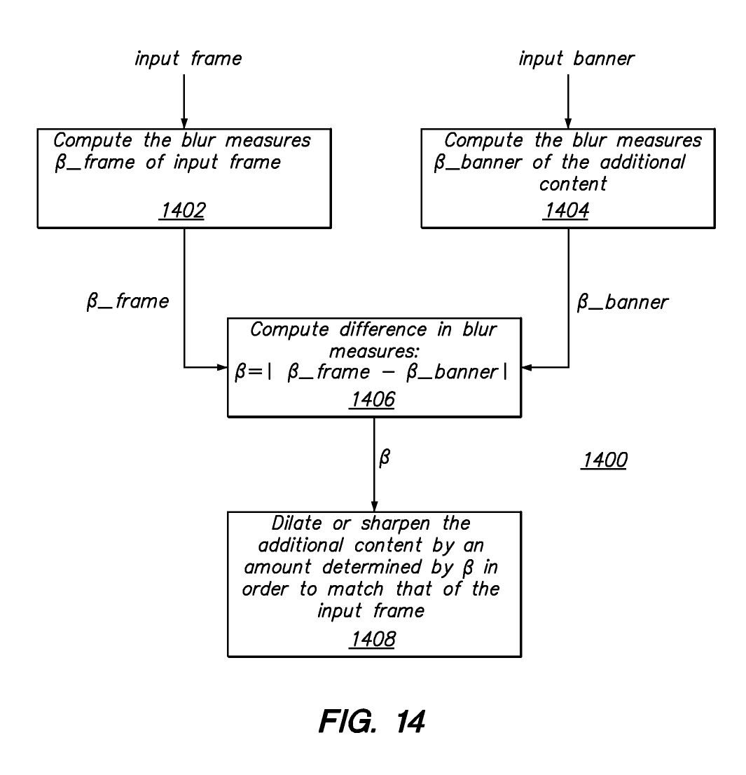

FIG. 14 illustrates a method 1400 of matching focus of additional content with focus of video frames in accordance with an embodiment of the present invention. Portions of the method 1400 can be performed in the steps 316 and 318 of FIG. 3 and in the step 1210 of FIG. 12.

More particularly, in a step 1402, a blur measure β_frame is computed for the input frame of the video clip 302, as described above in connection with step 316. Similarly, a blur measure β_banner is computed for the additional content as described above in connection with step 316.

In a step 1406, a difference β in the blur measures is determined. Then, in a step 1408, the additional content is dilated or sharpened by an amount determined by β in order to match that of the input frame. The steps 1406 and 1408 can be performed in the step 1210 of FIG. 12. Also, in step 1210, the perspective, scale, size and shape of the additional content 320 can be altered to be consistent with that of the outlined and tracked target area determined in steps 306-312.

Referring to FIG. 12, in a step 1212, the solution F_final, which represents the blended and adjusted additional content 320 is transferred to the corresponding input frame of the video clip 302. This process can be repeated for each frame in which the target area 304 appears.

Data Set Management

In a preferred embodiment, data is preprocessed to improve performance. Data that is preprocessed can include, for example, frame numbers containing additional content; coordinate locations of additional content; metadata from frame for blending; blur measure to be applied to additional content for blending; and occlusion information.

To store preprocessed data efficiently, a relational database and compressed flat files are preferably employed. The relational database can contain: (1) file locations for corner points, occlusion, blending metadata information; (2) frame numbers identifying the beginning and ending frame numbers where additional content is inserted; (3) occlusion frame numbers identifying the beginning and ending frame numbers where the target area is occluded; (4) video attributes such as frame size, video length, and video duration.

The compressed flat files can contain: (1); locations of target areas on frames (which may be referred to as a corner points file); (2) metadata for blending (which may be referred to as a metadata file); (3) blur measure data to be applied to additional content for blending; and (4) occlusion information (which may be referred to as an occlusion file).

The corner points file can include consolidated corner points data. Its size will generally be proportional to the number of frames tracked, the quantity of tracked areas and the size of the tracked areas. The metadata file can include metadata required for blending. Its size will generally be proportional to the number of frames tracked, the number of the quantity of tracked areas and the size of the tracked areas. The occlusion file can include a bitmap of occluding pixels. Its size will generally be proportional to the size of the video file.

As an example, the length of video clip can be 2 minutes, 45 seconds, with a frame size of 320×240 pixels and the target area size can be 50×50 with one target area per frame. In this case, the video file can be approximately 66 Mb in mov format. The corner points file can be approximately 1 Mb. The blending metadata file can be approximately 9 Mb proprietary and the occlusion file can be approximately 66 Mb in mov format. The data file containing the additional data (e.g. a corporate logo) can be approximately 0.01 Mb and can be in jpg or gif file format. In this example, the total data stored can be approximately 76 MB which is approximately 115% size of video file.

Additional data stored can include a blur measure for the target area for each video. Additional content will typically as sharp as possible. The blur measures for target areas are preferably determined during pre-processing. The determined blur measure for a target area is preferably the same regardless of the additional content. For example, the blur measure can be used for different corporate logos inserted into the same target area of the same video. The additional data stored can also include sets of logos from corporate advertisers. For example, companies may have the same logos in different colors or textures. The additional data may also include video compatible logo sets. This is because certain logos may not be compatible with a video based on background color or texture. The additional data may also include business-compatible logo sets. This is because it may be desired to restrict logos from competing advertisers from being placed into the same video.

The foregoing detailed description of the present invention is provided for the purposes of illustration and is not intended to be exhaustive or to limit the invention to the embodiments disclosed. It will be apparent to one skilled in the relevant art that variations will be encompassed by the spirit and scope of the invention and that the invention may be practiced in other embodiments. The particular division of functionality between the various system components described herein is merely exemplary. Thus, the methods and operations presented herein are not inherently related to any particular computer or other apparatus. Functions performed by a single system component may instead be performed by multiple components, and functions performed by multiple components may instead performed by a single component. It will also be apparent that process steps described herein can be embodied in software, firmware or hardware. Thus, the present invention or portions thereof may be implemented by apparatus for performing the operations herein. This apparatus may be specially constructed or configured, such as application specific integrated circuits (ASICs) or Field Programmable Gate Arrays (FPGAs), as a part of an ASIC, as a part of FPGA, or it may comprise a general-purpose computer selectively activated or reconfigured by a computer program stored on a computer readable medium that can be accessed and executed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, and or coupled to a computer system bus. Furthermore, the methods described in the specification may be implemented by a single processor or be implemented in architectures employing multiple processor designs for increased computing capability. Accordingly, the disclosure of the present invention is intended to be illustrative, but not limiting, of the scope of the invention. The scope of the present invention is defined by the appended claims.

What is claimed is:

1. A method of inserting image data into a target area of an image frame comprising:
obtaining a target area of an image frame;
obtaining boundary values for the target area of the image frame;
obtaining image data to be inserted into the image frame;
blending the image data according to the boundary values for the target area using spectral methods; and
inserting the blended image data into the target area of the image frame and displaying a resulting image frame on a display screen of a computing device.

2. The method according to claim 1, wherein the image frame is a portion of a video clip and further comprising repeating the steps of obtaining boundary values, calculating a vector B, solving a matrix equation using spectral methods and inserting blended image data into the target area of an image frame for each of a plurality of image frames of the video clip to generate a resulting video clip and further comprising displaying the resulting video clip on a display screen of a computing device.

3. The method according to claim 2 wherein the video clip is generated by photographing a three-dimensional tangible scene.

4. The method according to claim 1, further comprising determining a measure of focus for the image frame and adjusting a focus of the blended image data in accordance with the measure of focus for the image frame.

5. The method according to claim 1, wherein the boundary values for the target area are in perceptual log color scale and wherein the image data to be inserted into the image frame is in perceptual log color scale.

6. The method according to claim 1, wherein the spectral methods comprise Fast Fourier Transform.

7. The method according to claim 1, wherein said solving a matrix equation comprises solving nth order partial differential equations.

8. The method according to claim 7, wherein only the target area of the image frame is affected by said blending.

9. The method according to claim 8, wherein said solving a matrix equation employs Dirichlet boundary conditions.

10. The method according to claim 8, wherein said solving a matrix equation comprises solving second order Poisson partial differential equations.

11. The method according to claim 8, wherein said solving a matrix equation comprises solving fourth order Bi-harmonic partial differential equations.

12. The method according to claim 11, wherein said solving fourth order Bi-harmonic partial differential equations comprises:
generating second degree coupled partial differential equations;
using boundary values for the target area of the image frame to estimate a solution to the coupled partial differential equations; and
iteratively solving the coupled partial differential equations to generate a final solution.

13. The method according to claim 1, further comprising communicating the resulting image from a network server to the computing device via a computer network.

14. A method of inserting image data into a target area of an image frame comprising:
obtaining a target area of an image frame;
obtaining boundary values for the target area of the image frame;
determining a gradient for image data to be inserted into the image frame;
calculating a vector B from the boundary values and the gradient;
solving a matrix equation AF=B for the matrix F using spectral methods, the matrix A being a standard matrix and the matrix F representing blended image data; and
inserting the blended image data into the target area of the image frame and displaying a resulting image frame on a display screen of a computing device.

15. The method according to claim 14, wherein the image frame is a portion of a video clip and further comprising repeating the steps of obtaining boundary values, calculating a vector B, solving a matrix equation using spectral methods and inserting blended image data into the target area of an image frame for each of a plurality of image frames of the video clip to generate a resulting video clip and further comprising displaying the resulting video clip on a display screen of a computing device.

16. The method according to claim 15, wherein the video clip is generated by photographing a three-dimensional tangible scene.

17. The method according to claim 14, further comprising determining a measure of focus for the image frame and adjusting a focus of the blended image data in accordance with the measure of focus for the image frame.

18. The method according to claim 14, wherein the boundary values for the target area are in perceptual log color scale and wherein the image data to be inserted into the image frame is in perceptual log color scale.

19. The method according to claim 18, further comprising converting the matrix F from perceptual log color scale to a linear color scale.

20. The method according to claim 14, wherein the spectral methods comprise Fast Fourier Transform.

21. The method according to claim 14, wherein Fast Fourier Transform is employed to invert the matrix A.

22. The method according to claim 14, wherein said solving a matrix equation comprises solving nth order partial differential equations.

23. The method according to claim 22, wherein said solving a matrix equation employs Dirichlet boundary conditions.

24. The method according to claim 22, wherein said solving a matrix equation comprises solving second order Poisson partial differential equations.

25. The method according to claim 22, wherein said solving a matrix equation comprises solving fourth order Bi-harmonic partial differential equations.

26. The method according to claim 25, wherein said solving fourth order Bi-harmonic partial differential equations comprises:
generating second degree coupled partial differential equations;
using boundary values for the target area of the image frame to estimate a solution to the coupled partial differential equations; and
iteratively solving the coupled partial differential equations to generate a final solution.

27. The method according to claim 14, further comprising communicating the resulting image from a network server to the computing device via a computer network.

28. A system for inserting image data into a target area of an image frame comprising:
a network server configured to retrieve an image frame from data storage, the image frame having an identified target area; the network server being configured to obtain boundary values for the target area of the image frame; the network server being further configured to retrieve image data to be inserted into the image frame from data storage; and wherein the network server is further configured to blend the image data according to the boundary values for the target area using spectral methods; and wherein the network server is further configured to insert the blended image data into the target area of the image frame; and wherein the network server is further configured to communicate a resulting image to a computing device via a network for display by the computing device.

29. A non-transitory computer readable medium having stored thereon, a machine readable sequence of instructions, which when executed causes a computing device to perform a method of inserting image data into a target area of an image frame, the method comprising:
obtaining a target area of an image frame;
obtaining boundary values for the target area of the image frame;
obtaining image data to be inserted into the image frame;
blending the image data according to the boundary values for the target area using spectral methods; and
inserting the blended image data into the target area of the image frame and displaying a resulting image frame on a display screen of a computing device.

30. A method of augmenting a video clip comprising steps of:
obtaining a video clip comprising a sequence of frames, the video clip including a frame having an identified target area;
tracking the target area across a plurality of frames of the video clip;
identifying any occluding objects present within the tracked target area for each of the plurality of frames;
obtaining image data to be inserted into the tracked target area for each of the plurality of frames;
for each of the plurality of frames, blending the image data according to the boundary values for the target area using spectral methods, and inserting the blended image data into the target area of the image frame; and
displaying a resulting video clip on a display screen of a computing device.

31. The method according to claim 30, wherein said tracking the target area comprises:
identifying a plane in three-dimensional space for the target area, the target area being defined by a set a points on the plane;
estimating a position of the target area in a next frame of the video clip;
generating a transformation matrix from the position of the target area in the next frame; and
applying the transformation matrix to the target area to determine its position in the next frame of the video clip.

32. The method according to claim 31, further comprising comparing the estimated locations of points within the target area to their corresponding locations in the prior frame to determine frame-to-frame movement for each of the points and removing outliers based on said comparison and wherein said generating the transformation matrix estimated locations of points within the target area that are not outliers.

33. The method according to claim 30, wherein an occluding object at least partially occludes the target area and wherein, for each frame in which the occluding object at least partially occludes the target area said identifying any occluding objects comprises estimating a location of the occluding object in a frame of the video clip based on its location in a previous frame of the video clip and identifying pixels of the occluding object in the frame by generating a characteristic signature of the occluding object based on its estimated location and using the characteristic signature to separate pixels of the occluding object from pixels of the frame of the video clip and wherein said displaying the resulting video clip on a display screen of a computing device is performed so that the occluding object appears to pass in front of the inserted image data.

34. A non-transitory computer readable medium having stored thereon, a machine readable sequence of instructions, which when executed causes a computing device to perform a method of augmenting a video clip comprising steps of:
obtaining a video clip comprising a sequence of frames, the video clip including a frame having an identified target area;
tracking the target area across a plurality of frames of the video clip;
identifying any occluding objects present within the tracked target area for each of the plurality of frames;
obtaining image data to be inserted into the tracked target area for each of the plurality of frames;
for each of the plurality of frames, blending the image data according to the boundary values for the target area using spectral methods, and inserting the blended image data into the target area of the image frame; and
displaying a resulting video clip on a display screen of a computing device.
